(19) United States
(12) Patent Application Publication
(10) Pub. No.: US 2015/0348122 A1
(43) Pub. Date: Dec. 3, 2015

(54) METHODS AND SYSTEMS FOR PROVIDING PURCHASING OPPORTUNITIES BASED ON LOCATION-SPECIFIC BIOMETRIC DATA

(71) Applicant: UNITED VIDEO PROPERTIES, INC., SANTA CLARA, CA (US)

(72) Inventors: James Cornell, Chicago, IL (US); Andrew Fundament, Arlington Heights, IL (US); Melissa Bradley, Mt. Prospect, IL (US); Vanessa Wickenkamp, Elmhurst, IL (US); Andy Dustin, Palos Hills, IL (US)

(73) Assignee: UNITED VIDEO PROPERTIES, INC., SANTA CLARA, CA (US)

(21) Appl. No.: 14/291,495

(22) Filed: May 30, 2014

(51) Int. Cl. G06Q 30/02

(52) U.S. Cl. CPC G06Q 30/0269; G06Q 30/0261; G06Q 30/0267

(57) ABSTRACT

Methods and systems are disclosed for a media guidance application that performs one or more media guidance application operations based on the biometric state of a user. For example, the media guidance application can present customize media content and/or perform customize media guidance application operations that are targeted to a user based on both the current biometric state of the user and the current location of the user.

### BACKGROUND

Advances in mobile technology now allow users to consume media content in places and during activities in which they previously could not. For example, users today may receive multiple types of media content and from multiple content providers on user devices (e.g., smartphones, tablets, etc.) that are carried with the user. With so much content available, users may need help identifying particular media content that is of interest to them.

### SUMMARY

Accordingly, methods and systems are disclosed herein for a media guidance application that performs one or more media guidance application operations based on the biometric state of a user. For example, the media guidance application may recommend a media asset, select an advertisement, or perform another action based on whether or not the user is thirsty, tired, angry, etc. Furthermore, the media guidance application may further customize the media guidance application operation performed by selecting it based on location-specific biometric data.

For example, if users having the same biometric state as the current biometric state of the user (e.g., blood-alcohol content of 0.2 percent) typically perform a particular action (e.g., purchasing a particular alcohol drink) when at the location of the user (e.g., a particular liquor store), the media guidance application may recommend the same action to the user. For example, in response to determining that the user has a particular biometric state and is currently at a particular location, the media guidance application may determine purchasing opportunities that are typically accepted by other users (e.g., based on tracking the purchase history of one or more users) with the same biometric state and at the same location.

Accordingly, the media guidance application can present customized media content and/or perform customized media guidance application operations that are targeted to a user based on both the current biometric state of the user and the current location of the user. Given their customized nature, the media content and/or media guidance application operations generated for display and/or performed by the media guidance application have a higher likelihood of corresponding to the current wants and needs of users.

In some aspects, a media guidance application may determine a biometric state of a first user. For example, a user device, upon which the media guidance application is implemented, may monitor, or may incorporate or have access to another device that monitors, one or more physiological or psychological conditions of the user. For example, the media guidance application may receive data from a wearable electronic device such as wristbands, headwear, etc., that obtain biometric measurements (e.g., heart-rate, blood-pressure, etc.) of the user.

The media guidance application may also determine a location of the first user. For example, the media guidance application may receive a user input that indicates the current geographical coordinates, property type, or store brand in which the user currently resides. Alternatively or additionally, the media guidance application may automatically determine the current location of the user. For example, a user device, upon which the media guidance application is implemented, may use GPS data (e.g., received from a GPS device incorporated into or accessible by the media guidance application that identifies the current geographic coordinates), object-recognition data (e.g., received from an object-recognition module incorporated into or accessible by the media guidance application that identifies an object associated with a particular location), or other data to determine the current location of the user.

The media guidance application then cross-references the biometric state and the location with a database listing biometric states of users at the location to determine a second user that had the biometric state of the first user at the location. For example, the media guidance application may input the current biometric state of the user and the current location of the user into a database listing the various biometric states that one or more users had when at various locations. The media guidance application may then filter those listings to identify users that had the same biometric state of the user when at the same location as the user. Furthermore, in some embodiments, the database may further be filtered based on whether or not a potential second user has a demographic, familial, or social network relationship to the first user.

The media guidance application may then retrieve a purchase history for the second user to determine a purchase of the second user at the location. For example, in response to identifying a user that had the same biometric state when at the same location as the user, the media guidance application may determine whether or not that other user also purchased a product at the location. For example, the media guidance application may retrieve a purchase history (e.g., credit card statements, industry reports, market research reports, etc.) for the user to determine whether the user purchased (or likely purchased) a product at the location.

The media guidance application may then recommend a first purchasing opportunity for the first user based on the purchase of the second user at the location. For example, in response to determining that another user with the same biometric state as the current user purchased a product at the location, the media guidance application may recommend the same product to the current user. For example, the media guidance application may determine a user device associated with the first user that is at the location and generate for display an advertisement on the user device.

In some embodiments, the media guidance application may determine whether or not to offer the user a discount for the first purchasing opportunity based on whether the biometric state of the user indicates the user is more or less likely to accept the purchasing opportunity. For example, if a user is very thirsty, the media guidance application may determine that the user is more likely to purchase a drink. Therefore, the media guidance application may not offer a steep discount (e.g., generate for display a coupon). In contrast, if the user is only moderately thirsty, the media guidance application may determine that the user is less likely to purchase the drink. Therefore, the media guidance application may offer a steeper discount.

In some embodiments, the media guidance application may further determine a likelihood that the first user will accept the purchasing opportunity based on a purchase history of the first user. For example, despite evidence that suggests that other users sharing the same biometric state and at the same location bought a particular item, the media guidance application may determine that the user is unlikely to purchase the product based on the purchase history of the first user (e.g., indicating that the user never buys that particular product). For example, in response to determining that the first user is unlikely to accept the purchasing opportunity (e.g., purchase the product) based on the purchase history of the first user, recommending a different purchasing opportunity (e.g., advertising a different product for purchase).

In some embodiments, the media guidance application may determine a plurality of users that had the biometric state of the first user at the location based on the cross-reference of the biometric state and the location of the first user with a database listing biometric states of users at the location. The media guidance application may then recommend multiple purchasing opportunities associated with one or more of the plurality of users. Furthermore, in some embodiments, the media guidance application may rank the multiple purchasing opportunities on the likelihood that the user will accept a particular purchasing opportunity.

It should be noted that the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a display screen for use in performing media guidance application operations in accordance with some embodiments of the disclosure;

FIG. 2 shows another illustrative example of a display screen used to recommend purchasing opportunities for the first user based on location-specific biometric states in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is a flowchart of illustrative steps for recommending a first purchasing opportunity for a first user based on a purchase of the second user at a location in accordance with some embodiments of the disclosure; and

FIG. 6 is a flowchart of illustrative steps for recommending products purchased by identified users at a location in accordance with some embodiments of the disclosure.

### DETAILED DESCRIPTION OF THE DRAWINGS

Methods and systems are disclosed herein for a media guidance application that performs one or more media guidance application operations based on the biometric state of a user. For example, the media guidance application may recommend a media asset, select an advertisement, or perform another action based on whether or not the user is thirsty, tired, angry, etc. Furthermore, the media guidance application may further customize the media guidance application operation performed by selecting it based on location-specific biometric data. For example, the media guidance application can present customized media content and/or perform customized media guidance application operations that are targeted to a user based on both the current biometric state of the user and the current location of the user.

For example, if users having the same biometric state of as the current biometric state of the user (e.g., is in a sad mood), typically perform a particular action (e.g., buy chocolate) when at the location of the user (e.g., mini-mart), the media guidance application may recommend the same action to the user. For example, in response to determining that the user has a particular biometric state and is currently at a particular location, the media guidance application may determine purchasing opportunities that are typically accepted by other users (e.g., based on tracking the purchase history of one or more users) with the same biometric state and at the same location.

As referred to herein, a “media guidance application,” “interactive media guidance application,” or “guidance application” refers to an application that provides an interface that allows users to efficiently navigate content selections and easily identify content that they may desire. Media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content.

As referred to herein, the terms “media asset” and “content” should be understood to be interchangeable and to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media include any media capable of storing data. The computer readable media may be transitory, including, but not limited to, propagating electrical or electromagnetic signals, or may be non-transitory, including, but not limited to, volatile and non-volatile computer memory or storage devices such as a hard disk, floppy disk, USB drive, DVD, CD, media cards, register memory, processor caches, Random Access Memory (“RAM”), etc.

In some embodiments, a media guidance application may determine a biometric state of one or more users. As used herein, a “biometric state” refers to any qualitative or quantitative description of one or more biometric measurements related to a user. For example, a biometric state may describe a particular biometric measurement (e.g., the heart rate (in beats per minute), breath rate (in breaths per minute), blood pressure (in millimeters of mercury), etc.) of a user. A biometric state may alternatively or additionally describe a characteristic of a user relative to a baseline biometric state of the user (e.g., whether or not the user has a current attention level above or below the average attention level of the user) or relative to a baseline biometric state of an average user (e.g., whether or not the perspiration level of the user as measured by skin conductance is higher or lower than an average user in similar circumstances).

The media guidance application may further interpret or express the measurements in numerous techniques such as ratios, percentages, categories (e.g., high, normal, low), or using any other technique for distinguishing one biometric state from another. For example, a quantitative heart rate measurement (e.g., in beats per minute) may be converted into a qualitative reading (e.g., such as “Good” or “Bad”) when generated for display to the user.

As used herein, “a biometric measurement” refers to a distinctive, measurable characteristic used to label and describe the psychological or physiological condition of a user. For example, biometric measurements that may be received, managed, monitored, and/or shared by a media guidance application may include psychological characteristics related to the level of concentration, emotional state, mood, and/or pattern of behavior of a person, including but not limited to typing rhythm, gait, frequency of social interactions, voice tones, etc., or may include physiological characteristics related to the status and/or shape of the body such as height, weight, medical condition(s), heart rate, blood pressure, fingerprint, body mass index, glucose level, face description, DNA, palm print, hand geometry, iris recognition, retina, odor/scent, and/or any other mechanical, physical, and biochemical functions of a user, his/her organs, and the cells of which they are composed.

In some embodiments, the media guidance application may determine a psychological or physiological condition of a user based on one or more biometric measurements. For example, the media guidance application may determine the current mood of a user based on the heart rate, drowsiness level, or current brain activity of the user. In another example, the media guidance application may determine the level of attention of a user based on current brain activity, eye contact, etc. Systems and methods for determining moods, levels of attention, and other characteristics of a user based on brain activity are discussed in greater detail in connection with Klappert et al., U.S. patent application Ser. No. 14/038,158, filed Sep. 26, 2013; Klappert et al., U.S. patent application Ser. No. 14/038,046, filed Sep. 26, 2013; Klappert et al., U.S. patent application Ser. No. 14/038,171, filed Sep. 26, 2013; Klappert et al., U.S. patent application Ser. No. 14/038,257, filed Sep. 26, 2013; Klappert et al., U.S. patent application Ser. No. 14/037,984, filed Sep. 26, 2013; and Klappert et al., U.S. patent application Ser. No. 14/038,044, filed Sep. 26, 2013, which are hereby incorporated by reference herein in their entireties.

It should be noted that any embodiment associated with the receipt, management, monitoring, and/or sharing of one or more biometric measurements (or biometric state) may also be applied to the receipt, management, monitoring, and/or sharing of any other biometric measurements (or biometric state).

In some embodiments, information related to biometric measurements and/or psychological or physiological conditions of a user, including any settings associated with the receipt, management, monitoring, and/or sharing of one or more biometric measurements and/or psychological or physiological conditions of the user may be stored in a user profile. User profiles may also include compilations of media content interests of the user.

In some embodiments, the biometric state of the user involves receiving data from a device attached to the user. For example, the biometric monitoring device may be a device worn or held by a user such as an armband, wristband, eyeglasses, or other wearable electronic device. Alternatively or additionally, the media guidance application may monitor biometric states of a user using a detection module incorporated into or accessible by the media guidance application, or a device upon which the media guidance application is implemented.

In some embodiments, a media guidance application may monitor and/or store a baseline biometric state of the first user. For example, the media guidance application may store a “normal” or a baseline biometric state of the user and use that stored state for comparison with a current state of a user. The results of the comparison (and any variance therein) may be used by the media guidance application to define the current biometric state of a user.

For example, in some embodiments, the biometric state of a user may be defined by the presence of one or more biometric measurements. For example, the media guidance application may cross-reference the one or more biometric measurements in a database to determine a biometric state that is associated with those one or more biometric measurements. Alternatively or additionally, the media guidance application may cross-reference a difference from a baseline biometric state of a user of the one or more biometric measurements in a database to determine a biometric state that is associated with the difference. The baseline biometric state and/or the one or more biometric measurements associated with a biometric state of the user may be stored (e.g., in a user profile) or may be maintained on one or more devices.

In some embodiments, the media guidance application may determine a current biometric state of the first user is inconsistent with the baseline biometric state of the first user. Based on this determination, the media guidance application may determine a location of the user. For example, the media guidance application may detect any variations in the biometric state of a user. As referred to herein, a first biometric state (or a biometric measurement of the first biometric state) is inconsistent with a second biometric state (or a biometric measurement of the second biometric state) when the biometric measurements of the first biometric state do not correspond to the biometric measurements of the second biometric state within an acceptable threshold.

For example, in some embodiments, a threshold range of biometric measurements are associated with a particular biometric. The range of biometric measurements may account for any transient variations in a biometric state. For example, a threshold range of a biometric state may be defined as an average biometric measurement over a particular period of time. In addition, a threshold range for a biometric state may refer to a composite range that includes one or more biometric measurements that describe the biometric state.

For example, in response to detecting that a current biometric state of a user includes one or more biometric measurements that are outside a threshold variance of one or more biometric measurements of the baseline biometric state, the media guidance application may determine the current biometric state of the user is inconsistent (e.g., outside the acceptable threshold) with the baseline biometric state of the user.

In response to detecting the inconsistency, the media guidance application may perform one or more media guidance application operations. For example, the media guidance application may determine a current location of the user in response to determining the inconsistency. Additionally or alternatively, the performance of one or more media guidance application operations may be keyed to a determination that the current location of a user is associated with information (e.g., biometric states, purchase histories, etc.) associated with another user.

As used herein, “location” refers to any relative or absolute identifier of a position of a user. For example, the location of the user may be relative to a geographical coordinate, vector for direction, street address, name of building, or any other suitable identifier. In another example, the location may be relative to a property type (e.g., restaurant, hardware store, movie theatre, post-office, personal residence, place of business, etc.). As referred to herein, a “property type” refers to a location associated with a specific purpose or function. Furthermore, the purpose or function may be relative to a particular user. For example, while a location may represent a worksite to one user, the same location may represent a place of leisure to another user.

In some embodiments, the location may also refer to a store brand. For example, the location may refer to a particular entity that governs, administers, and/or controls the location. For example, the media guidance application may determine that a single location refers to two franchises of the same restaurant, even though the geographic coordinates of the franchises are different. For example, while, in some embodiments, a location may be indicated by coordinates in a geographic coordinate system (e.g., latitude or longitude), or a global positioning system (GPS), in some embodiments, additionally or alternatively, a location may be determined by other information such as the property type or store brand. The retrieved information may define the bounds and proximities that determine whether or not the user is in a particular location. Furthermore, the information may indicate whether or not the position of the user is associated with multiple locations.

The media guidance application may receive this information in numerous ways. For example, the media guidance application may receive a user input that indicates the current geographic coordinates, property type, or store brand in which the user currently resides. For example, upon arriving at a location the media guidance application may receive a user input of a name of the location. In another example, upon arriving at a location, the user may scan a barcode or other identifier that indicates to the media guidance application the location of the user. Alternatively or additionally, the media guidance application may automatically determine the current location of the user (e.g., without receiving a manual user input or the need for a user to scan a barcode or other identifier).

In some embodiments, a user device, upon which the media guidance application is implemented, may use GPS data (e.g., received from a GPS device incorporated into or accessible by the media guidance application that identifies the current geographic coordinates), object-recognition data (e.g., received from a object-recognition module incorporated into or accessible by the media guidance application that identifies an object associated with a particular location), or other data to determine the current location of the user.

In some embodiments, the media guidance application cross-references the biometric state and the location with a database listing biometric states of users at the location to determine a second user that had the biometric state of the first user at the location. For example, the media guidance application may input the current biometric state of the user and the current location of the user into a database listing the various biometric states that one or more users had when at various locations. The media guidance application may then filter those listings to identify users that had the same biometric state of the user when at the same location as the user. Furthermore, in some embodiments, the database may further be filtered based on whether or not a potential second user has a demographic, familial, or social network relationship to the first user. For example, in addition to targeting a user based on the location-specific biometrics, the media guidance application may also target the user based on any other criteria such as the age, race, income level, participation in a social media network, etc.

It should be noted that the database, and/or the records therein, listing biometric states of users may be compiled using numerous techniques. For example, in some embodiments, the biometric states and locations of user may be tracked when making in purchases and/or performing any other media guidance application operation. For example, the locations and/or other users may have detection modules or other devices (e.g., as described herein) capable of recording a biometric state of a user. The tracked information may then be stored in a central repository, which can thereafter be access by one or more media guidance applications.

Alternatively or additionally, a user may indicate to the media guidance application what media guidance application operations should be tracked, recorded, shared, and with whom the information should be shared. For example, as discussed below in relation to FIG. 2, the media guidance application may present the user with in a interface that can be used to edit and establish settings for managing media guidance application operations (e.g., purchasing opportunities) based on location-specific biometrics.

In some embodiments, the media guidance application may retrieve a purchase history (and/or any other information related to one or more users) for use in performing a media guidance application operation. For example, the media guidance application may retrieve a purchase history of one or more users to determine whether or not a user purchased one or more goods or services at a location. For example, in response to identifying a user that had the same biometric state when at the same location as the user, the media guidance application may determine whether or not that other user also purchased a product at the location.

In some embodiments, the media guidance application may retrieve a purchase history and/or any other information about users from user profiles (e.g., stored at a local or remote source that includes data related to prior purchases, user preferences, interests, demographics, familial relationships, social network relationships, etc., such as credit card statements, industry reports, market research reports, online associations, membership status in one or more group, and/or any other information accessible to one or more profiling systems or services. In some embodiments, this information may be used to determine whether the user purchased (or likely purchased) a product at the location.

For example, the media guidance application may score data related to a particular user to determine a likelihood that one or more users may perform a particular action (e.g., accept a purchasing opportunity. This likelihood may be based on past actions of the particular user (e.g., prior purchases of the user) and/or the actions of users in general (e.g., the media guidance application may determine a percentage of the population as a whole that performs the action given the current circumstances). In some embodiments, the media guidance application may invoke one or more algorithms to score the data. For example, the algorithms may weigh data of one or more types (and/or weigh the data differently based on the type) to determine the score. The score may then be used to determine the likelihood (e.g., a higher score corresponds to a higher likelihood) that a user will perform a particular action.

In some embodiments, the media guidance application may recommend a first purchasing opportunity for the first user based on the purchase of the second user at the location. As used herein, a “purchasing opportunity” refers to a communication to a user related to a product or service available for consumption by the user. For example, a purchasing opportunity may include any offer, promotion, advertisement, and/or other data related to a product or service that is available, whether directly or indirectly to a user. For example, in response to determining that another user with the same biometric state as the current user purchased a product at the location, the media guidance application may recommend the same product to the current user. For example, the media guidance application may determine a user device associated with the first user that is at the location and generate for display an advertisement on the user device.

In some embodiments, the media guidance application may determine whether or not to offer the user a discount for the first purchasing opportunity based on whether the biometric state of the user indicates the user is more or less likely to accept the purchasing opportunity. For example, if a user is very thirsty, the media guidance application may determine that the user is more likely to purchase a drink. Therefore, the media guidance application may not offer a steep discount (e.g., generate for display a coupon). In contrast, if the user is only moderately thirsty, the media guidance application may determine that the user is less likely to purchase the drink. Therefore, the media guidance application may offer a steeper discount.

In some embodiments, the media guidance application may further determine a likelihood that the first user will accept the purchasing opportunity based on a purchase history of the first user. For example, despite evidence that suggests that other users sharing the same biometric state and at the same location, bought a particular item, the media guidance application may determine that the user is unlikely to purchase the product based on the purchase history of the first user (e.g., indicating that the user never buys that particular product). For example, in response to determining that the first user is unlikely to accept the purchasing opportunity (e.g., purchase the product) based on the purchase history of the first user, the media guidance application may recommend a different purchasing opportunity (e.g., advertising a different product for purchase).

In some embodiments, the media guidance application may determine a plurality of users that had the biometric state of the first user at the location based on the cross-reference of the biometric state and the location of the first user with a database listing biometric states of users at the location. The media guidance application may then recommend multiple purchasing opportunities associated with one or more of the plurality of users. Furthermore, in some embodiments, the media guidance application may rank the multiple purchasing opportunities on the likelihood that the user will accept a particular purchasing opportunity.

It should be noted that while embodiments of this disclosure refer to recommending purchasing opportunities to a user (e.g., a media guidance application operation), those same embodiments may equally be applied to performing one or more other media guidance application operations. For example, instead of cross-referencing the biometric state of a first user and the location of the first user in a database to determine a purchase of a second user at that location, the media guidance application may cross-reference the biometric state of the first user and the location of the first user in the database to determine any media guidance application operation performed by the second user at that location. The media guidance application may then recommend, or automatically perform that media guidance application operation, in response to determining that the first user is at the location.

As referred to herein, a “media guidance application operation” refers to any operation corresponding to providing, receiving, and/or generating media guidance data for consumption by a user. For example, media guidance application operations include displaying media guidance data, providing options to navigate, select, and edit media guidance data or content (e.g., a media asset) associated with media guidance data, and/or manipulating a device used to access (e.g., a display device), retrieve (e.g., a server), and/or associate media guidance data with a user (e.g., a user device for monitoring brain activity).

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

Other operations of a media guidance application are to play media assets and provide fast access playback operations for those media assets. As referred to herein, the phrase “fast-access playback operations” should be understood to mean any media guidance application operation that pertains to playing back a non-linear media asset faster than normal playback speed or in a different order than the media asset is designed to be played, such as a fast-forward, rewind, skip, chapter selection, segment selection, skip segment, jump segment, next segment, previous segment, skip advertisement or commercial, next chapter, previous chapter or any other operation that does not play back the media asset at normal playback speed. The fast-access playback operation may be any playback operation that is not “play,” where the play operation plays back the media asset at normal playback speed.

Still other operations of media guidance application may include the control of devices used to consume media assets. For example, a media guidance application operation may include turning a device on and off, raising the volume associated with a device, adjusting the display settings of a device, assigning parental controls, transferring information from one device to another, storing and/or recording content, entering authorization information and/or payment information, etc.

In some embodiments, a media guidance application operation may relate to a social media activity such as publicly distributing a media asset and/or receiving information from a social media network. For example, the media guidance application may retrieve a list of friends (e.g., a social network buddy list), contacts (e.g., retrieved from a phone/text message/e-mail account associated with the user), and/or other listings featuring other entities with known associations to the user and distribute the notification and/or media assets to contacts.

As used herein, a “social network” refers to a platform that facilitates networking and/or social relations among people who, for example, share interests, activities, backgrounds, and/or real-life connections. In some cases, social networks may facilitate communication between multiple user devices (e.g., computers, televisions, smartphones, tablets, etc.) associated with different users by exchanging content from one device to another via a social media server. As used herein, a “social media server” refers to a computer server that facilitates a social network. For example, a social media server owned/operated/used by a social media provider may make content (e.g., status updates, microblog posts, images, graphic messages, etc.) associated with a first user accessible to a second user that is within the same social network as the first user. In such cases, classes of entities may correspond to the level of access and/or the amount or type of content associated with a first user that is accessible to a second user.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

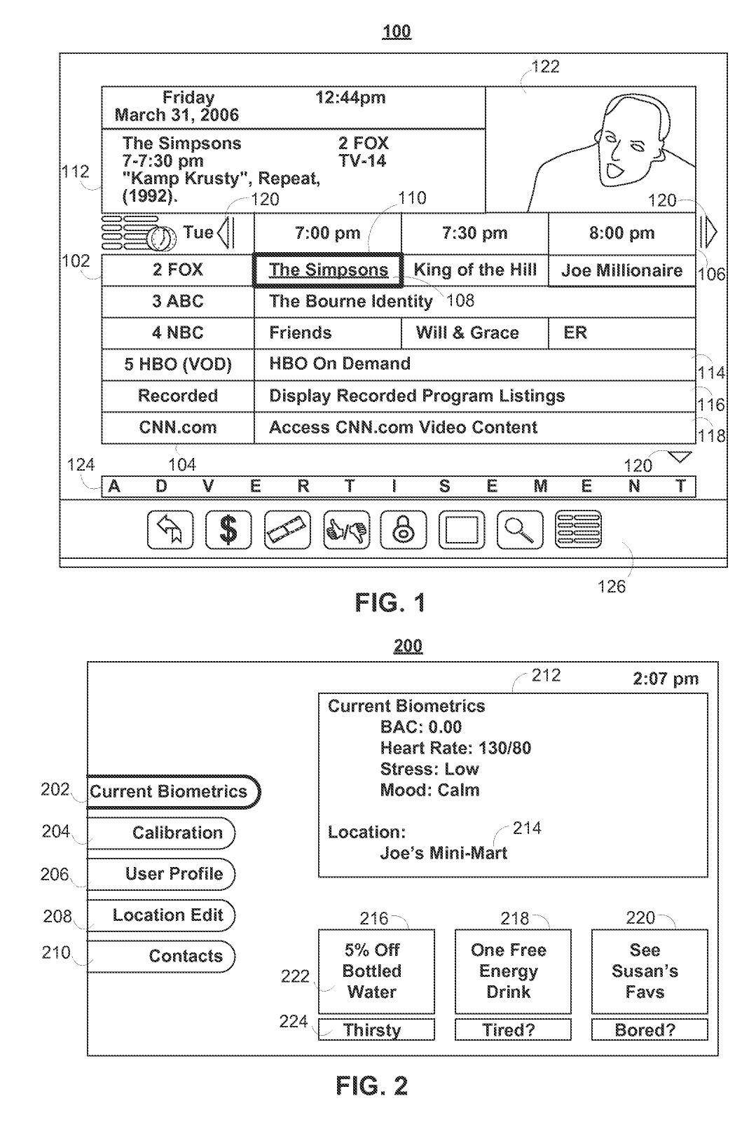

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

FIG. 2 shows another illustrative example of a display screen used to recommend purchasing opportunities for the first user based on location-specific biometric states in accordance with some embodiments of the disclosure. For example, option 202 is currently selected. In response, the media guidance application has generated window 212, which lists various biometric states and/or biometric measurements currently pertaining to the user. In addition, window 212 indicates a current location of the user (e.g., location 214). In some embodiments, the media guidance application may receive user inputs indicating what biometric measurements and/or biometric states that the media guidance application should monitor for.

Display 200 also includes other windows. For example, display 200 includes purchasing opportunities 216, 218, and 220. Purchasing opportunities may include graphical images including cover art, still images, video clip previews, live video advertisements, or other types of content that indicate to a user the content associated with the purchasing opportunity. Each of the graphical images may also be accompanied by text, overlaid on, or adjacent to the graphical image, to provide further information about the content associated with purchasing opportunities 216, 218, and 220. For example, purchasing opportunity 216 may include more than one portion, such as graphical portion 222 and text portion 224. Graphical portion 222 and/or text portion 224 may be selectable to view content in full-screen, to accept the purchasing opportunity, and/or to view information related to the content displayed in graphic portion 222.

The purchasing opportunities in display 200 are of the same sizes, but if desired, all the purchasing opportunities may be of different sizes. For example, the size, accentuation, and/or position of windows associated with the purchasing opportunities may vary to indicate degrees of interest to the user or to emphasize certain content, as desired by the content provider or based on user preferences. For example, the media guidance application may generate for display purchasing opportunities with a higher rank in a window that is larger than purchasing opportunities with a lower rank. Various systems and methods for graphically accentuating content listings are discussed in, for example, Yates, U.S. Patent Application Publication No. 2010/0153885, filed Dec. 29, 2005, which is hereby incorporated by reference herein in its entirety.

Display 200 also includes numerous selectable options associated with the performance of one or more media guidance application operations. For example, option 204 may allow a user to calibrate the media guidance application. For example, in response to a user selection of option 204, the media guidance application may calibrate and/or perform a training/set-up mode. For example, the media guidance application may receive information from the user, in which the user describes and/or rates his or her current biometric state. For example, during calibration, the media guidance application may detect a biometric state and ask the user to describe the biometric state (e.g., designate the state as associated with a particular mood). The current biometric state of the user (e.g., the current threshold range) will then be designated as corresponding to the particular mood. Additionally or alternatively, the media guidance application may receive instructions designating a particular biometric state as corresponding to a particular mood. For example, the media guidance application may retrieve/receive instructions that indicate that a threshold range of 8 to 10 breaths a minute indicates that the particular user is in a happy mood. Additionally, the media guidance application may retrieve/receive instructions that indicate that a blood-alcohol concentration of 0.08 indicates that the particular user is inebriated.

Display 200 also includes option 206. Option 206 may allow a user to access and/or modify a user profile associated with the user. For example, the media guidance application may allow a user to set preferences and/or other criteria for purchasing opportunity recommendations. Furthermore, the media guidance application may allow the user to connect multiple user devices and/or accounts (e.g., a social media account) together to share profile information. Additionally or alternatively, the media guidance application may allow a user to establish privacy settings, parental controls, and/or any other options related to the media guidance application.

Display 200 also includes option 208. Option 206 may allow a user to access and/or modify one or more locations associated with the user. For example, the media guidance application may allow a user to designate one or more locations with nicknames (e.g., “Joe's House) and/or other designations that affect the purchasing opportunities recommended while at that location.

Display 200 also includes option 210. Option 210 may allow a user to indicate contacts and/or other relationships that should be used by the media guidance application to determine other users that should be considered when recommending purchasing opportunities. For example, the media guidance application may receive user input indicating particular people for which the biometric data of those people should affect the purchasing opportunities recommended to the user.

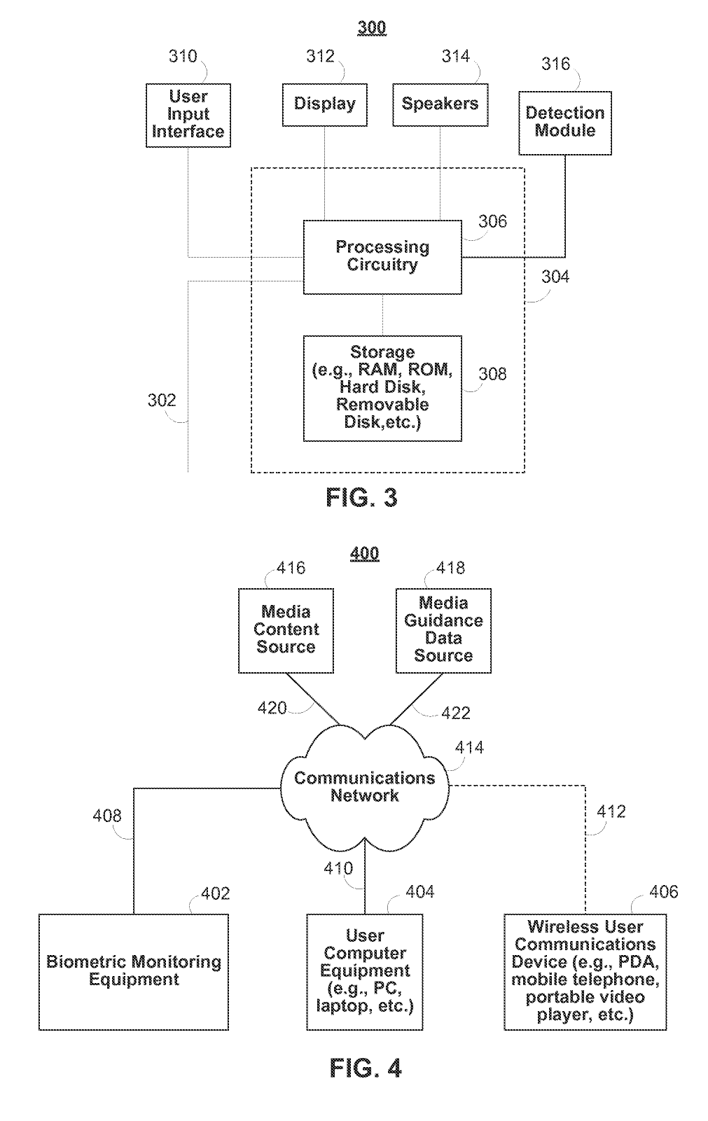

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature polysilicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

Detection module 316, or the detection module circuitry, may be incorporated into, coupled to, or accessible by the media guidance application (e.g., via control circuitry 304). Detection module 316 may be used to measure, monitor, identify, and determine biometric data, a current biometric state of a user, and/or a location of the user. For example, the media guidance application may receive from detection module 316 data describing the biometric state of a user.

For example, the media guidance application, or the user device upon which the media guidance application is implemented, may incorporate and/or have access to a plurality of sensors and/or monitoring components. In some embodiments, the media guidance application, or the user device upon which the media guidance application is implemented, may incorporate and/or have access to an electroencephalogram unit (“EEG”). An EEG measures electrical activity associated with a brain of a user. For example, an EEG may measure voltage fluctuations and/or the frequency or frequency range of voltage fluctuations generated by the brain of a user. In some embodiments, the media guidance application, or the user device upon which the media guidance application is implemented, may incorporate and/or have access to an electromyogram unit (“EMG”). An EMG measures the electrical activity of nerves controlling muscles at rest and during contraction.

In some embodiments, the media guidance application, or the user device upon which the media guidance application is implemented, may incorporate and/or have access to a heart monitor, glucose blood meter, respiratory monitors, devices for obtaining tissue, blood, and/or any other suitable samples from a user, and/or any other devices necessary for determining the biometric measurements of the user.

In some embodiments, display 200 may indicate psychological and/or physiological conditions to monitor in addition to, or as an alternative to, individual biometrics to monitor. For example, if the media guidance application monitors a mood of the user, the media guidance application may monitor for multiple biometric measurements in order to monitor the mood. For example, the media guidance application may compare the breathing rate (e.g., determined via a respiratory monitor), blood pressure (e.g., via a blood pressure monitor), alpha wave activity (e.g., via a EKG), and muscle tension (e.g., via an EMG) to determine the particular mood a user is currently experiencing. Thus, in response to selecting to monitor a mood of the user, the media guidance application may obtain data from a plurality of devices and/or obtain a plurality of biometric measurements.

Detection module 316 may also calibrate biometric measurements based on the user. For example, the media guidance application may calibrate the various biometric measurements based on the typical measurement of the user (e.g., a baseline biometric state) and/or skewing caused by a particular sensor or monitoring component. For example, the media guidance application may track the biometrics of the user (e.g., in a personal log stored in storage 308), which tracks various biometric measurements of the user.

In some embodiments, detection module 316 may include a Global Positioning System (“GPS”) detection component, which determines or receives information describing the geographic coordinates of a user or an object associated with a user (e.g., a smartphone) for use in determining a location of a user.

Additionally or alternatively, the media guidance application may determine the biometric state of a user or the location of the user by applying one or more content recognition techniques. For example, detection module 316 may record the biometric state of the user and analyze the biometric state of the user for one or more indicators of a biometric state or a particular biometric measurement. For example, the media guidance application (e.g., via control circuitry 304) may use a content recognition module or algorithm to generate data describing the context, content, and/or any other data necessary for determining a biometric state or a particular biometric measurement. For example, the content recognition module may use object recognition techniques such as edge detection, pattern recognition, including, but not limited to, self-learning systems (e.g., neural networks), optical character recognition, on-line character recognition (including, but not limited to, dynamic character recognition, real-time character recognition, intelligent character recognition), and/or any other suitable technique or method to analyze recorded behavior of a user. For example, the media guidance application may receive data in the form of a video. The video may include a series of frames. For each frame of the video, the media guidance application may use a content recognition module or algorithm to determine the objects (e.g., people, places, things, etc.) in each of the frames or series of frames, which may be used to determine a biometric state or a particular biometric measurement. For example, the media guidance application may analyze each frame of the video to determine the number of times that a user breathes (e.g., by detecting the rise and fall of the chest of a user) over the length of the video. The media guidance application may then compare this determination (e.g., the breath rate of the user) to determine a biometric measurement.

In another example, the media guidance application may analyze each frame of the video to determine an address displayed on a street sign, a trademark displayed in a restaurant, barcode associated with a location, etc. over the length of the video. The media guidance application may then compare this determination object to a database that indicates a location of the object. For example, the media guidance application may compare a street address with a database on map information to determine the current address of the user. In another example, the media guidance application may compare a trademark, barcode, serial number, etc. captured in a building to determine the type of property and/or the store brand.

In some embodiments, the content recognition module or algorithm may also include speech recognition techniques, including, but not limited to, Hidden Markov Models, dynamic time warping, and/or neural networks (as described above) to translate spoken words into text and/or processing audio data. The content recognition module may also combine multiple techniques to determine a biometric state, a particular biometric measurement, or a location. For example, if the media guidance application determines the user is out of breath or laboring to breathe based on sounds coming from the user, the media guidance application may use this information to determine the current biometric state or a particular biometric measurement of the user. In another example, if the user (or another person) states the name of a location, the media guidance application may determine the current location of the user.

In addition, the media guidance application may use multiple types of optical character recognition and/or fuzzy logic, for example, when processing keyword(s) retrieved from data (e.g., textual data, translated audio data, user inputs, etc.) describing a biometric state, a biometric measurement, a location, and/or any other information (e.g., when cross-referencing various types of data in databases). For example, if the particular data received is textual data, using fuzzy logic, the media guidance application (e.g., via a content recognition module or algorithm incorporated into, or accessible by, the media guidance application) may determine two fields and/or values to be identical even though the substance of the data or value (e.g., two different spellings) is not identical.

In some embodiments, the media guidance application may analyze particular received data of a data structure or media asset frame for particular values or text using optical character recognition methods described above in order to determine a characteristic of a media asset. For example, the media guidance application may process the spoken words of the user to find particular keywords that may be indicative of a current biometric state, particular biometric measurement, and/or location.

The guidance application may be implemented using any suitable architecture. For example, it may be a stand-alone application wholly implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates the likelihood a given user will terminate access to a service/source. For example, the media guidance application may process the viewer data with the subscription data using the model to generate a value or score that indicates the likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

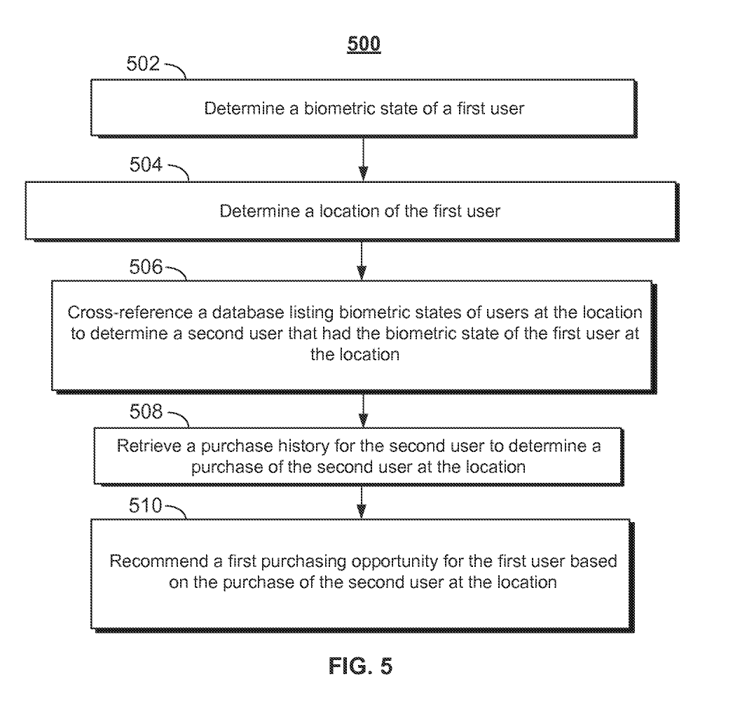

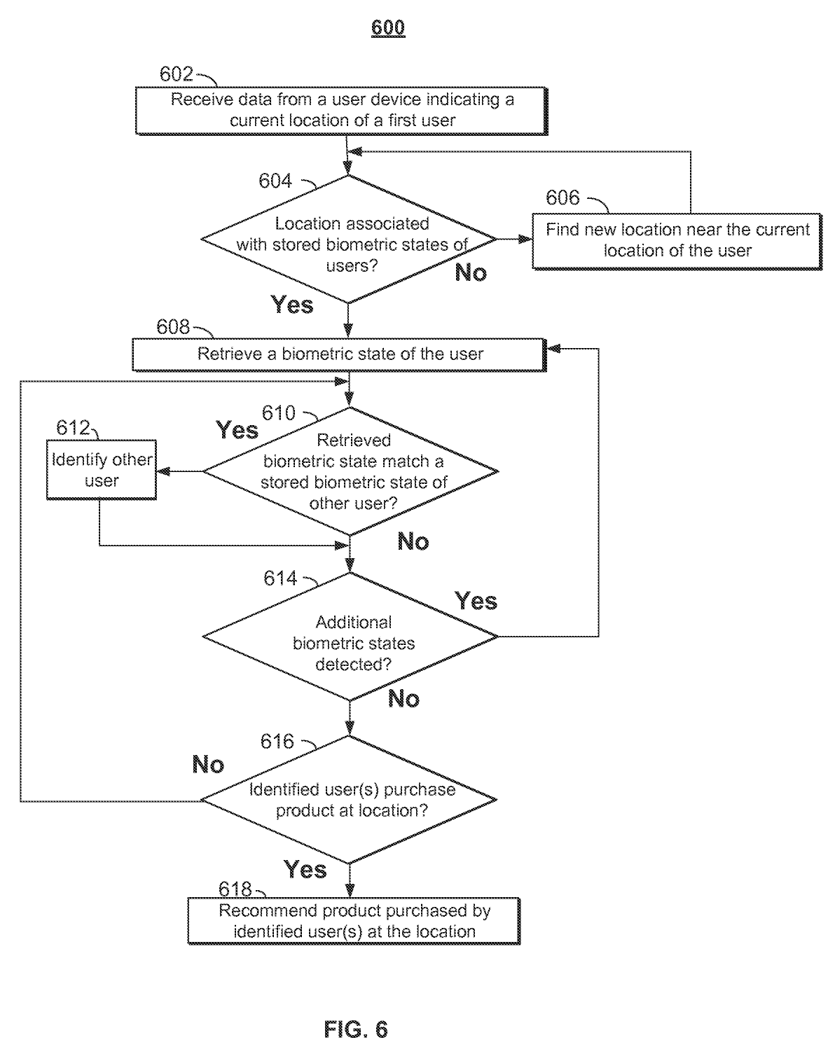

FIG. 5 is a flowchart of illustrative steps for recommending a first purchasing opportunity for a first user based on a purchase of the second user at a location. It should be noted that process 500 or any step thereof could be performed on, or provided by, any of the devices shown in FIGS. 3-4. For example, process 500 may be executed by control circuitry 304 (FIG. 3) as instructed by a media guidance application implemented on a user device (e.g., user equipment devices 402, 404, and/or 406 (FIG. 4)) in order to recommend a first purchasing opportunity for a first user based on a purchase of the second user at a location. In addition, one or more steps of process 500 may be incorporated into or combined with one or more steps of any other process or embodiment (e.g., process 600 (FIG. 6)).

At step 502, the media guidance application may determine (e.g., via control circuitry 304 (FIG. 3)) a biometric state of a first user. For example, a user device (e.g., device 300 (FIG. 3)), upon which the media guidance application is implemented, may monitor (e.g., via detection module 316 (FIG. 3)), or may incorporate or have access to another device that monitors, one or more physiological or physiological conditions of the user. For example, the media guidance application may receive data from a wearable electronic device such as wristbands, headwear, etc. that obtain biometric measurements (e.g., heart-rate, blood-pressure, etc.) of the user.

In some embodiments, the media guidance application may store (e.g., at storage 308 (FIG. 3) and/or at any location accessible via communications network 414 (FIG. 4)) the data received while monitoring the user. For example, the media guidance application may track the biometric measurements of a user over a particular period of time to determine (e.g., via control circuitry 304 (FIG. 3)) an average biometric measurement and/or biometric state for the particular period of time.

At step 504, the media guidance application determines (e.g., via control circuitry 304 (FIG. 3)) a location of the first user. For example, the media guidance application may receive a user input (e.g., via user input interface 310 (FIG. 3)) that indicates the current geographical coordinates, property type, or store brand in which the user currently resides. Alternatively or additionally, the media guidance application may automatically determine (e.g., via control circuitry 304 (FIG. 3)) the current location of the user (e.g., via detection module 316 (FIG. 3)). For example, a user device, upon which the media guidance application is implemented, may use GPS data, object-recognition data or other data from a detection module (e.g., detection module 316 (FIG. 3)) to determine the current location of the user.

At step 506, the media guidance application cross-references the biometric state and the location with a database (e.g., located at storage 308 (FIG. 3) and/or any location accessible via communications network 414 (FIG. 4)) listing biometric states of users at the location to determine a second user that had the biometric state of the first user at the location. For example, the media guidance application (e.g., via control circuitry 304 (FIG. 3)) may input the current biometric state of the user and the current location of the user into the database listing the various biometric states that one or more users had when at various locations. The media guidance application may then filter (e.g., via control circuitry 304 (FIG. 3)) those listings to identify (e.g., via control circuitry 304 (FIG. 3)) users that had the same biometric state of the user when at the same location as the user.

Furthermore, in some embodiments, the database may further be filtered based on whether or not a potential second user has a demographic, familial, or social network relationship to the first user. For example, in some embodiments, the media guidance application may select and/or perform one or more media guidance application operations (e.g., recommend a purchasing opportunity) based on location-specific biometric data that is also targeted to a specific age group. For example, the media guidance application may determine a purchase that another user at the same location, with the same biometric state, and the same age group as the current user and recommend a purchasing opportunity based on that purchase to the current user.

It should also be noted that in some embodiments, demographic or other relationship information of a user may be used to determine a media guidance application operation to perform irrespective of whether or not location or biometric state information is used. For example, the media guidance application may determine a purchase that another user with one or more of the same location, the same biometric state, or the same age group as the current user and recommend a purchasing opportunity based on that purchase to the current user.

At step 508, the media guidance application retrieves (e.g., via control circuitry 304 (FIG. 3)) a purchase history for the second user to determine a purchase of the second user at the location. For example, in response to identifying (e.g., via control circuitry 304 (FIG. 3)) a user that had the same biometric state when at the same location as the user, the media guidance application may determine (e.g., via control circuitry 304 (FIG. 3)) whether or not that other user also purchased a product at the location. For example, the media guidance application may retrieve (e.g., from storage 308 (FIG. 3) and/or any location accessible via communications network 414 (FIG. 4)) a purchase history (e.g., credit card statements, industry reports, market research reports, etc.) for the user to determine (e.g., via control circuitry 304 (FIG. 3)) whether the user purchased (or likely purchased) a product at the location.

At step 510, the media guidance application recommends (e.g., in display 200 (FIG. 2) on user equipment device 402, 404, and/or 406 (FIG. 4)) a first purchasing opportunity for the first user based on the purchase of the second user at the location. For example, in response to determining (e.g., via control circuitry 304 (FIG. 3)) that another user with the same biometric state as the current user purchased a product at the location, the media guidance application may recommend the same product to the current user. For example, the media guidance application may determine (e.g., via control circuitry 304 (FIG. 3)) a user device associated with the first user that is at the location and generate for display an advertisement on the user device.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 5.

FIG. 6 is a flowchart of illustrative steps for recommending products purchased by identified users at a location. It should be noted that process 600 or any step thereof could be performed on, or provided by, any of the devices shown in FIGS. 3-4. For example, process 600 may be executed by control circuitry 304 (FIG. 3) as instructed by a media guidance application implemented on a user device (e.g., user equipment devices 402, 404, and/or 406 (FIG. 4)) in order to recommend products purchased by identified users at a location. In addition, one or more steps of process 600 may be incorporated into or combined with one or more steps of any other process or embodiment (e.g., process 500 (FIG. 5)).

At step 602, the media guidance application receives data from a user device indicating a current location of a first user. For example, the media guidance application may receive (e.g., via user input interface 310 (FIG. 3)) a user input that indicates the current geographic coordinates, property type, or store brand in which the user currently resides. For example, upon arriving at a location, the media guidance application may receive a user input of a name of the location. In another example, upon arriving at a location, the user may scan (e.g., using detection module 316 (FIG. 3)) a barcode or other identifier that indicates to the media guidance application the location of the user. Alternatively or additionally, the media guidance application may automatically determine (e.g., via control circuitry 304 (FIG. 3)) the current location of the user (e.g., without receiving a manual user input or the need for a user to scan a barcode or other identifier). In some embodiments, a detection module (e.g., detection module 316 (FIG. 3)), upon which the media guidance application is implemented, may use GPS data, object-recognition data, or other data to determine the current location of the user.

At step 604, the media guidance application determines (e.g., via control circuitry 304 (FIG. 3)) whether or not the location is associated with stored biometric states of users. For example, in response to determining the user is at a location, the media guidance application may cross-reference the location with a database that lists locations that have associated biometric states for one or more users. For example, the media guidance application may receive (e.g., from storage 308 (FIG. 3) and/or any location accessible via communications network 414 (FIG. 4)) a list of locations for which the media guidance application can perform media guidance application operations based on location-specific biometric states. The media guidance application may determine (e.g., via control circuitry 304 (FIG. 3)) whether or not the current location corresponds to a listing in the database.

If the media guidance application determines that the location is not associated with stored biometric states of users, the media guidance application proceeds to step 606. At step 606, the media guidance application finds a new location near the current location of the user. For example, in response to determining that the media guidance application cannot perform media guidance application operations based on location-specific biometric states for the current location, the media guidance application may determine another location, near the current location, for which it can perform media guidance application operations based on location-specific biometric states. At step 606, the media guidance application finds a new location and returns to step 604.

If the media guidance application determines that the location is associated with stored biometric states of users, the media guidance application proceeds to step 608. At step 608, the media guidance application retrieves a biometric state of the user. For example, as discussed above, the media guidance application may determine (e.g., via control circuitry 304 (FIG. 3)) a biometric state of the user. For example, a user device (e.g., device 300 (FIG. 3)), upon which the media guidance application is implemented, may monitor (e.g., via detection module 316 (FIG. 3)), or may incorporate or have access to another device that monitors, one or more physiological or physiological conditions of the user. For example, in some embodiments, the media guidance application may receive data from a wearable electronic device such as wristbands, headwear, etc. that obtain biometric measurements (e.g., heart-rate, blood-pressure, etc.) of the user.

In some embodiments, the media guidance application may store (e.g., at storage 308 (FIG. 3) and/or at any location accessible via communications network 414 (FIG. 4)) the data received while monitoring the user. For example, the media guidance application may track the biometric measurements of a user over a particular period of time to determine (e.g., via control circuitry 304 (FIG. 3)) an average biometric measurement and/or biometric state for the particular period of time. The media guidance application may retrieve this data at step 608.

At step 610, the media guidance application determines whether or not the retrieved biometric state matches a stored biometric state of other user. For example, as discussed above, the media guidance application may cross-reference the biometric state with a database (e.g., located at storage 308 (FIG. 3) and/or any location accessible via communications network 414 (FIG. 4)) listing biometric states of users at the location to determine other users that had the biometric state of the user at the location. For example, the media guidance application (e.g., via control circuitry 304 (FIG. 3)) may input the current biometric state of the user into the database listing the various biometric states that one or more users had when at various locations. The media guidance application may then filter (e.g., via control circuitry 304 (FIG. 3)) those listings to identify (e.g., via control circuitry 304 (FIG. 3)) users that had the same biometric state of the user. Furthermore, in some embodiments, the database may further be filtered based on whether or not a potential second user has a demographic, familial, or social network relationship to the first user.

If the media guidance application determines (e.g., via control circuitry 304 (FIG. 3)) that a retrieved biometric state matches a stored biometric state of other user, the media guidance application proceeds to step 612 and identifies the user before proceeding to step 614. If the media guidance application does not determine (e.g., via control circuitry 304 (FIG. 3)) a retrieved biometric state matches a stored biometric state of other user, the media guidance application proceeds directly to step 614.

At step 614, the media guidance application determines whether additional biometric states are detected. For example, in some embodiments, the media guidance application may monitor (e.g., via detection module 316 (FIG. 3)) for multiple biometric states. In some embodiments, the media guidance application may determine which biometric states and/or biometric measurements to monitor for based on a user input (e.g., via option 202 (FIG. 2)).

If the media guidance application determines (e.g., via control circuitry 304 (FIG. 3)) there are additional biometric states and/or biometric measurements detected, the media guidance application returns to step 608. If the media guidance application determines (e.g., via control circuitry 304 (FIG. 3)) there are no additional biometric states and/or biometric measurements detected, the media guidance application proceeds to step 616.

At step 616, the media guidance application determines whether or not an identified user purchased a product at the location. For example, as discussed above, the media guidance application may retrieve (e.g., via control circuitry 304 (FIG. 3)) a purchase history (e.g., stored at storage 308 (FIG. 3) and/or any location accessible via communications network 414 (FIG. 4)) for the identified user (e.g., based on credit card statements, industry reports, market research reports, etc.) to determine whether or not the identified user purchased a product or service at the location.

If the media guidance application determines (e.g., via control circuitry 304 (FIG. 3)) that the identified user purchased a product at the location, the media guidance application proceeds to step 618 and recommends (e.g., as shown in FIG. 2)) one or more products purchased by one or more of the identified users at the location. If the media guidance application determines (e.g., via control circuitry 304 (FIG. 3)) that the identified user did not purchase a product at the location, the media guidance application returns to 610 to identify another user. It should be noted that, in some embodiments, the media guidance application may perform one or more iterations of portions of process 600 in order to recommend multiple products purchased by multiple identified users.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 6.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method for recommending purchasing opportunities, the method comprising:
determining a biometric state of a first user;
determining a location of the first user;
cross-referencing the biometric state and the location with a database listing biometric states of users at the location to determine a second user that had the biometric state of the first user at the location;
retrieving a purchase history for the second user to determine a purchase of the second user at the location; and
recommending a first purchasing opportunity for the first user based on the purchase of the second user at the location.

2. The method of claim 1, further comprising:
determining that the first user is unlikely to accept the purchasing opportunity based on a purchase history of the first user; and
in response to determining that the first user is unlikely to accept the purchasing opportunity based on a purchase history of the first user, recommending a different purchasing opportunity.

3. The method of claim 1, further comprising recommending a second purchasing opportunity for the first user based on a purchase of a third user at the location.

4. The method of claim 3, further comprising ranking the first purchasing opportunity and the second purchasing opportunity based on a likelihood that the user will accept the first purchasing opportunity or the second purchasing opportunity.

5. The method of claim 1, further comprising determining whether to offer the user a discount for the first purchasing opportunity based on whether the biometric state of the user indicates the user is more or less likely to accept the purchasing opportunity.

6. The method of claim 1, wherein the database lists users associated with the first user by a demographic, familial, or social network relationship.

7. The method of claim 1, wherein recommending the first purchasing opportunity for the first user based on the purchase of the second user at the location, further comprises:
determining a user device associated with the first user that is at the location; and
generating for display an advertisement on the user device.

8. The method of claim 1, wherein determining the location of the first user, further comprises:
determining a user device associated with the first user; and
receiving data from the user device indicating that the first user is at the location.

9. The method of claim 1, wherein the location is associated with a set of geographic coordinates, a property type, or a store brand.

10. The method of claim 1, wherein the biometric state of the first user is determined based on data received from a wearable electronic device.

11. A system for recommending purchasing opportunities, the system comprising:
storage circuitry configured to store a database listing biometric states of users; and
control circuitry configured to:
determine a biometric state of a first user;
determine a location of the first user;
cross-reference the biometric state and the location with a database listing biometric states of users at the location to determine a second user that had the biometric state of the first user at the location;
retrieve a purchase history for the second user to determine a purchase of the second user at the location; and
recommend a first purchasing opportunity for the first user based on the purchase of the second user at the location.

12. The system of claim 11, wherein the control circuitry is further configured to:
determine that the first user is unlikely to accept the purchasing opportunity based on a purchase history of the first user; and
in response to determining that the first user is unlikely to accept the purchasing opportunity based on a purchase history of the first user, recommend a different purchasing opportunity.

13. The system of claim 11, wherein the control circuitry is further configured to recommend a second purchasing opportunity for the first user based on a purchase of a third user at the location.

14. The system of claim 13, wherein the control circuitry is further configured to rank the first purchasing opportunity and the second purchasing opportunity based on a likelihood that the user will accept the first purchasing opportunity or the second purchasing opportunity.

15. The system of claim 11, wherein the control circuitry is further configured to determine whether to offer the user a discount for the first purchasing opportunity based on whether the biometric state of the user indicates the user is more or less likely to accept the purchasing opportunity.

16. The system of claim 11, wherein the database lists users associated with the first user by a demographic, familial, or social network relationship.

17. The system of claim 11, wherein the control circuitry configured to recommend the first purchasing opportunity for the first user based on the purchase of the second user at the location, is further configured to:
determine a user device associated with the first user that is at the location; and
generate for display an advertisement on the user device.

18. The system of claim 11, wherein the control circuitry configured to determine the location of the first user, is further configured to:
determine a user device associated with the first user; and
receive data from the user device indicating that the first user is at the location.

19. The system of claim 11, wherein the location is associated with a set of geographic coordinates, a property type, or a store brand.

20. The system of claim 11, wherein the biometric state of the first user is determined based on data received from a wearable electronic device.

21-50. (canceled)
